(19) United States
(12) Patent Application Publication
(10) Pub. No.: US 2008/0062979 A1
(43) Pub. Date: Mar. 13, 2008

(54) Real Time Communications System

(76) Inventor: Christian Garnier, Etrechy (FR)

Correspondence Address: YOUNG & THOMPSON, 745 SOUTH 23RD STREET, 2ND FLOOR, ARLINGTON, VA, 22202, US

(21) Appl. No.: 11/662,890

(22) PCT Filed: Sep. 13, 2005
(86) PCT No.: PCT/FR05/02261

§ 371 Date: Mar. 15, 2007

(30) Foreign Application Priority Data
Sep. 16, 2004 (FR) 0409799

(51) Int. Cl. H04L 29/06

(52) U.S. Cl. 370/389

(57) ABSTRACT

A real time communications systems between at least two equipments includes a circuit for producing information “CPI” for transmission, and at least one circuit for consuming the information “CCI”, communications elements for transferring information “CMTI”, WRITE function command elements, signaling elements for signaling emitted by the CMTI to the CPI to provide a write report in response to the information transferred after information of the WRITE function, and elements for defining an optional event to enable the CMTI to inform the CPI that the information has been read by the CCI, elements for defining an optional event enabling the CMTI to inform the CCI that information is present, READ function command elements, and signaling elements for enabling the CMTI to deliver information to the CCI.

The present invention relates to real time electronic communications systems.

It is well-known that it is at present becoming more and more necessary to proceed with exchanges of data via communications circuits between equipments that persons skilled in the art refer to as “distant processes”.

To satisfy that problem, the electronic architectures that have already been implemented rely on communications means that provide high data rates, that guarantee deterministic behavior, and that guarantee services, e.g. synchronization or the provision of a time relationship between systems.

Communications means that are known, e.g. as industrial local area networks (ILANs) are nowadays coming to the limits of their functionality. In order to replace them, numerous lines of research have been followed, in particular in avionics and automation.

All of that research has been based on computer standards (e.g. Ethernet) since industry seeks to obtain solutions that are long-lasting. It is even possible to achieve better results for obtaining such lasting quality, for example by re-using means that are mass-produced, together with great connectivity, and a large amount of modularity in order to provide the system with good upgradeability and high performance, where necessary.

Although in an office environment the approaches mentioned above appear to be effective, in the context of so-called “real time” systems it should be observed that there is a certain amount of contradiction between implementing solutions that are widespread and the constraints of real time operation.

In particular, the distribution of data in an already-known multiprocessor system, e.g. as disclosed in the document entitled “Distributed simulation communication through an active real-time database” in the name of Marcus Brohede and Sten F. Andler, published in the journal Software Engineering Workshop, 2002 Proceedings 27th Annual NASA Goddard/IEEE, December 5-6, Piscataway, N.J., USA, IEEE of Dec. 5, 2002, pp. 147-155, makes it possible, by means of a “software bus”, to distribute the data produced to the various processes that consume it, while naturally complying with the properties inherent to each of the data items transmitted.

That embodiment according to that prior document requires a large amount of software development which, in order to operate, relies on the operating system. That embodiment as created in that way consumes a very large amount of the computation power of the central processor unit (CPU). In order to operate, that structure can busy up to 70% or even 80% of the power of the CPU. The power consumed varies in proportion to the amount of data exchange and to the systems services used.

This first drawback is associated with a second drawback that is completely unacceptable in “real time” applications. The latency time for handling data distribution is entirely dependent on the instantaneous loading of the operating system. This latency time can, by itself, represent several hundreds of microseconds (or even several milliseconds, since it depends entirely on the data transmission process relative to other processes of the application). This on its own explains why the above-referenced article refers to “simulating distributed communications” and not to describing an industrially applicable embodiment that needs a latency time that is minimal and deterministic.

Thus, an object of the present invention is to provide a “real time” communications system that satisfies both the desires of industry and the constraints imposed by applications, i.e. devices that are to be implemented, while defining a communications architecture based on a host structure that enables data to be well distributed in a system by high-performance communications means, and, in the event of constraints inherent to the application that can be satisfied at any moment, with all of this naturally being achieved while complying with a high level of abstraction and above all using computer standards that are known and acceptable to all concerned and that provide much higher performance than similar or like systems in the prior art.

Another object of the present invention is to provide a host structure for said real time communications system, which structure is transparent while being embodied using computer standards, and that is capable of interconnecting a plurality of equipments constructed using non-uniform architectures such as computer backplane buses, operating systems, and programming languages such as those known for example as C, C++, . . . .

Another object of the present invention is to provide a communications system in which the host structure satisfies all of the applicable constraints, such as in particular, deterministic transfers, data integrity, and needs for synchronization.

More precisely, the present invention provides a real time communications system between at least two equipments, the system being characterized in that it comprises:

a circuit for producing information “CPI” to be transmitted and at least one circuit for consuming said information “CCI”;

communications means for transferring information “CMTI”; and

firstly mounted in co-operation between said CPI and said CMTI:
WRITE function command means;
signaling means for emitting signaling from the CMTI to the CPI to provide a write report in response to the transfer of the information following initialization of the WRITE function; and
means for defining an optional event to enable the CMTI to inform the CPI that the information has been read by the CCI; and

secondly mounted in co-operation between the CCI and the CMTI:
means for defining an optional event enabling the CMTI to inform the CCI that information is present;
READ function command means; and
signaling means for enabling the CMTI to cause the information for the CCI to be delivered to the CCI; and at least

two real time distributed databases associated with the CMTI and respectively functionally associated with the CPI and with the CCI.

Other characteristics and advantages of the invention appear from the following description given with reference to the accompanying drawings by way of non-limiting illustration, in which:

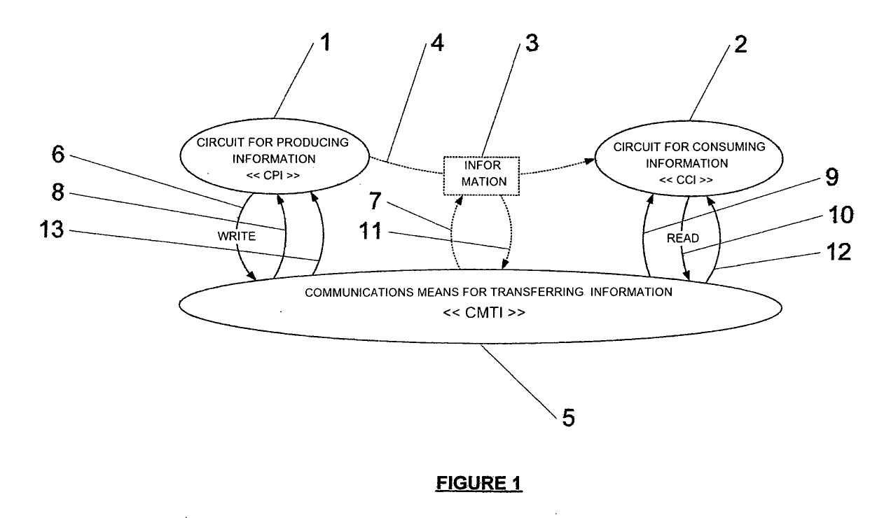

FIGS. 1 to 4 are functional block diagrams showing variant embodiments of the real time communications system of the invention.

It is initially specified that in the figures, the same references designate the same elements regardless of the figure in which they appear and regardless of the way in which the elements are shown. Similarly, if elements are not specifically referenced in one of the figures, their references can easily be discovered by referring to another figure.

FIG. 1 is a basic block diagram for the real time communications system of the invention, e.g. between at least two equipments 14 and 15.

Under such circumstances, the system comprises at least one circuit 1 for producing information for transmission, referred to below as “CPI”, and at least one circuit 2 for consuming said information, referred to below as “CCI”, it being specified that in the meaning of the present invention, the term “information” covers any data and/or data set of any kind in computer form, that are well-known in themselves in the field of transmission, and in particular in the field of real time transmission.

The system further comprises communications means for transferring information 5 referred to below as “CMTI”, and associated with the CPI 1 and the CCI 2.

As shown diagrammatically in FIG. 1, the CPI 1 is functionally connected to the CMTI 5 by:

WRITE function control means 6;

signaling means 8 for signaling emitted from the CMTI to the CPI in order to deliver a write report in response to the transfer of information following initialization of the WRITE function 6; and

means 13 for defining an optional event in order to enable the CMTI 5 to inform the CPI 1 that information has been read.

The CCI 2 is functionally connected to the CMTI 5 by:

means 9 for defining an optional event enabling the CMTI 5 to inform the CCI 2 that information is present;

READ function control means 10; and

signaling means 12 to enable the CMTI 5 to deliver the information to the CCI 2.

The dashed lines used for representing elements 3, 4, 7, and 11 serve merely to define virtual functions between the CPI 1 and the CPI 2 via the CMTI 5. In particular, 3 represents storage of the information that is to be conveyed, mentioning that the information stored at 3 is to be transferred, via the path 4 from the CPI 1 to the CCI 2 in order to provide communications between them, e.g. to effect “one-to-one” type transfers, as well as “one-to-N” type transfers.

7 repents the function of storing information coming from the CMTI 5, and 11 represents reading the information stored in the CMTI 5 in order to make it available, e.g. to the CCI 2 via the above-defined means 12.

The WRITE command 6 enables the CPI 1 to write the data e.g. using methods of the so-called “message queue” type. Once writing has been performed, returns to an execution status at the CPI 1, and depending on the activation criteria, triggers the command for the CCI 2.

In turn, by using the READ command 10, the CCI 2 performs reading that triggers reading of the information data. The return from the function 12 contains the data. The CMTI 5 can thus warn the CPI 1 via signaling 8.

The characteristics of the above-described system are advantageous, in particular because of the following:

data exchanges take place under the control of the CMTI 5 which guarantee the integrity of the information data 3 given thereto;

this type of communication is very practical so long as the communication is of the “one-to-one” type; and

this exchange mechanism based on logical sharing also makes it possible to perform “one-to-N possibilities” type communication.

The system of the invention can advantageously provide both “one-to-one” type communication and “one-to-N” type communication.

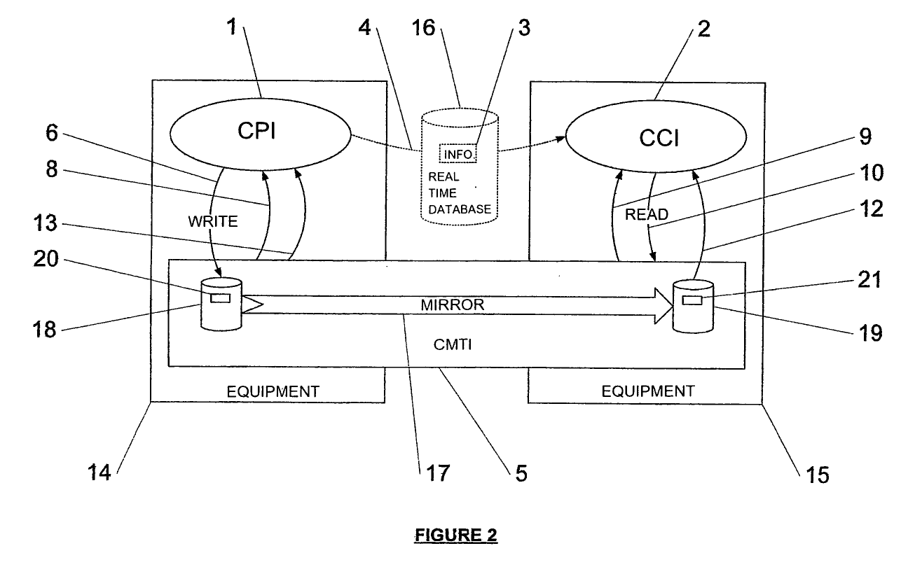

FIG. 2 shows another embodiment of the system of the invention, using characteristics of the embodiment of FIG. 1, with this figure further comprising, in order to enable the invention to be better understood, e.g. two equipments 14, 15 which are associated with a real time communications system of the invention.

In this embodiment, the CPI 1 is mounted to co-operate with the equipment 14, while the CPI 2 is mounted to co-operate with the equipment 15. By way of example, the equipments 14 and/or 15 may be radars, computers, inertial units for avionics, etc., suitable for being controlled in real time by orders in the form of information data, either all together or else separately.

In addition, the memory 3, which is represented functionally, is contained in a real time distributed database represented virtually at 16 and mounted to co-operate with the CMTI 5. As shown in FIG. 2, the database 16 is constituted by two real time distributed databases 18 and 19 associated with the CMTI 5 and functionally associated respectively with the CPI 1 and the CCI 2. The memories of these distributed databases 18 and 19 are shown diagrammatically at 20 and 21, and they are equivalent to the virtual memory represented at 3. In addition, in this embodiment, the CMTI 5 are arranged to implement a mirror function 17 that is known per se.

In general, the distributed database(s) of the system of the invention, such as the databases 18 and 19 in the embodiment shown in FIG. 2, are defined as means enabling all of the data produced by the equipments 14 to be made available to the CCI(s) 2 via the CPI 1. This structure as defined in this way makes it possible to comply with all criteria for integrity that are applicable to the information data.

The communications system of the invention thus connects a local database 18, 19 to each production circuit 1 or consumption circuit 2, which databases contain all of the information produced or consumed by the equipments 14, 15.

As mentioned above, the CPI 1 is arranged to effect a WRITE command 6. This command is taken into account by the CMTI 5 which writes the data in the local database 18 or 19, and then delivers the data in execution status to the equipments 14, 15.

Thus, as from this instant, the information is sent to the remote local databases 18 or 19 that need this information. In addition, a signal may be activated in order to warn the CCI 2, via 9.

In addition, each CPI 1 is arranged to read the data via a READ command 10. This command is processed by the CMTI 5 that can read the data and transmit it to the CCI 2 together with a status containing the validity of the information. The CMTI 5 can also send an acknowledgment to the CPI 1, via 13.

It is nevertheless specified that the communications system of the invention can operate if, and only if, the local distributed databases 18, 19 contain information that is consistent, i.e.:

i) consistent in space meaning that all of the data items duplicated in the CMTI 5 are identical; and

ii) consistent in time meaning that all of the data items have identical values at the same moment.

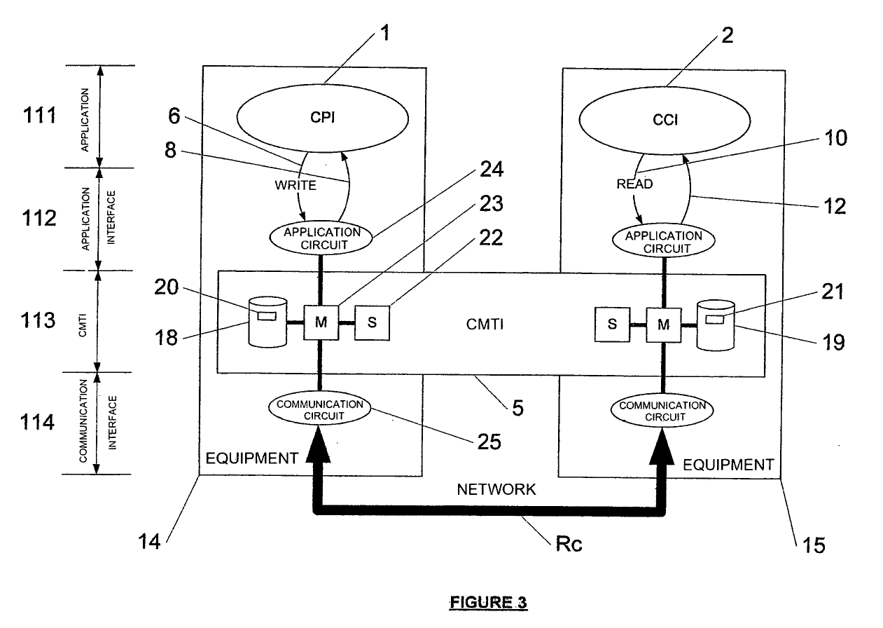

These two above conditions i) and ii) generate the need for a communications network referenced Rc in FIG. 3. Such a network, well-known in itself, interconnects all of the local databases 18, 19, as shown in FIG. 3 and as described below.

It is also necessary for the communications system to be suitable for identifying all of the data of the application device, i.e. of the equipments 14, 15 in order to enable predetermined functions to be performed, for example in avionics: real time control of different tasks or proper operation of the aircraft, with local level processing being applied only to functions that are produced or consumed by the circuits concerned by the commands for the application device.

The functionality of the communications system of the invention must include elements that it is necessary to address in order to obtain consistent operation of the system. In particular, it is necessary for data integrity to be associated in uniform manner throughout the system, for the mirror concept to require the need for data to be broadcast in the CMTI 5, and for the quality of service of the communications system, although dependent on the performance of the communications means used, to be consistent concerning the functionalities implemented in the CMTI 5 relating to the needs of the application.

For this purpose, all data transfers are performed under the control of the CMTI 5 which serves equally to authorize communication of “one-to-one” type and of “one-to-N” type.

Under the above-defined conditions, the system of the invention most advantageously comprises a layer structure, as shown diagrammatically in FIG. 3, of logical type for providing communication between mutually remote circuits, respectively producing and consuming information.

This layer structure comprises four layers 111, 112, 113, and 114 which comprise in substance:

The first layer 111 is constituted by the CPI 1 and the CCI 2 which act as clients and generate requests (READ and/or WRITE) to the application circuits 24 which themselves behave as “servers” for the equipments 14 and 15, i.e. as elements having functions that are interchangeable, one being capable of becoming a CPI 1 and the other a CCI 2, and vice versa.

In association with each circuit 1 and 2, the second layer 112 is constituted by applications circuits 24 which are the applications servers relying on the layer 113.

The third layer 113 is constituted by the CMTI 5 which integrate the databases 18, 19 in which the information 20 and 21 is stored to which access can be obtained only via access method circuits 23 so as to guarantee the integrity of the information. This layer also includes service means 22. FIG. 3 shows an embodiment of this functional structure that is described below.

The fourth layer 114 is constituted by a set of means, the communications circuit 25 which acts as data “servers” with respect to a client, and the network Rc which enables the CMTI to exchange information between remote equipments 14, 15.

The above-described structure in logic layers ensures complete independence between the real time communications system of the invention and the information producing and consuming circuits, as shown in FIG. 3. It is made up of three so-called “real time” layers 112, 113, and 114.

The second layer 112 is constituted by applications interface means that behave like a real time data service relative to the CPI 1 and/or the CCI 2. It relies on the CMTI 5 and handles all data transfers between the application device and the communications space.

The third layer 113 is constituted by means of the communications space. This third layer thus behaves like a layer that is transverse to all of the equipments 14, 15. It makes a local database 18, 19, i.e. an image of the above-defined distributed virtual database 16, available to the local circuits, i.e. the CPIs 1 or the CCIs 2. It guarantees the integrity of the distributed data by implementing access methods. It provides services and, for example, manages time.

Finally, the fourth layer 114 is constituted by interface means of the above-defined network Rc, these network interface means behaving like a real time data server relative to the network, i.e. the CMTI 5. It relies on the CMTI and manages all data transfers between the network Rc and the CMTI.

With this structure, it is thus clear that the system of the invention provides independence between the application device (the set of equipments 14, 5, . . . ) and the CPI 1 and/or CCI 2 with a high level of abstraction.

FIG. 3 also shows an embodiment of the system of the invention having all of the characteristics of the embodiments of FIGS. 1 and 2, but in which the system further comprises, in the implementation of the CMTI and mounted to co-operate with the above-defined elements referenced 24, 18, 20, and 25:

an access methods circuit 23 for guaranteeing the integrity of the information contained in the CMTI by implementing methods of accessing the data; and

the service means 22 which are distributed in the CMTI 5, e.g. to provide services for time- and date-stamping and synchronizing the various CPIs 1 and CCIs 2.

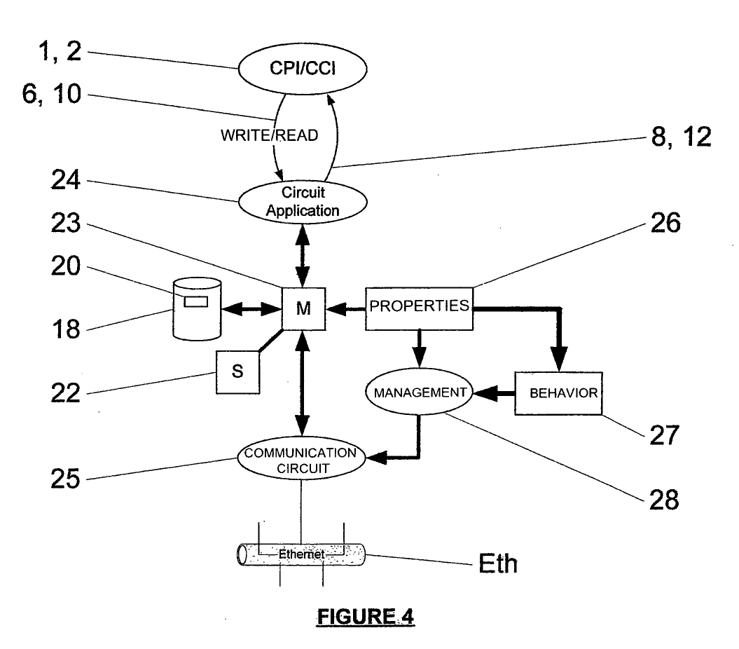

FIG. 4 shows an embodiment of the CMTI that is improved compared with the embodiment shown in FIG. 3. In this figure, the network Rc is embodied by an Ethernet network, by way of example.

In the embodiment shown in FIG. 4, the system further comprises, associated with each CPI 1 and CCI 2, and mounted to co-operate with the above-defined circuits 23 and 25:

a properties logic unit 26 which manages the functional consistency of all of the circuits provided in the CMTI 5 by means of the properties that are specific thereto and that are associated in bijective (one-to-one) manner with each item of information;

a circuit for managing methods of access to the information obtained at the output from the circuit 23 so that the information is coherent for the CMTI 5 as a whole but different depending on the type of access to the information contained in the database 19, 20 and depending on the orders received from 6 and 8 from the CPIs/CCIs 1/2 and the application circuits 24 and the communications circuits 25;

a behavior circuit 27 which, as a function of the information properties given by the logic unit 26, delivers the information to be applied during the transfer of information in the CMTI 5; and

a management circuit 28 which copies information between the remote databases 18, 19 in application of the behavior associated with each item of information transmitted by the behavior circuit 27.

The communications system of the invention presents significant advantages compared with systems known in the prior art.

In particular, it makes two types of communication possible, so-called “real time” communication by message with individual commands of the READ and WRITE type, and “non-real time” communication in which the system behaves like an individual medium access control (MAC) layer that is relied on by the libraries known to persons skilled in the art by the acronym TCP/UDP—IP (transfer control protocol/user datagram protocol—Internet protocol) that is known in the field of prior art systems and that enables application communications to be performed, but not in real time.

It also provides complete transparency relative to the application device (set of equipments 14, 15, . . . ) and great simplicity of implementation, thus providing a communicating structure in a non-uniform medium. It also guarantees the integrity of the data that is transmitted and/or processed. It provides complete separation between circuits that make communication possible and the application device(s), because the communications means have no impact either on the computation power or on the respective priority levels between the application device and the communications means.

Another advantage of the system is the modularity of its structure. The hardware adaptation layer (HAL), a subassembly making up the layer 112 provides a high level of upgradeability. It enables connections to be made to various equipments or the like, merely by changing the driver, such as for example adapting to different backplanes. In the same manner, the communications adaptation layer (CAL), the subassembly constituting the layer 114 makes it possible to use the system of the invention in various technical fields that can be very different from one another.

The operation of the real time communications system of the invention, an example of which is described above, can be understood by a person skilled in the art without any difficulty from the above description, and that is why it is not developed more fully herein solely for the purpose of keeping the present description simple.

From the above description, it is clear that the system of the invention presents a fundamental difference relative to the system described in the document mentioned in the introduction to this description. This difference lies essentially in the fact that the distributed databases referenced respectively 18 and 19, and all of the processing functional means enabling data to be distributed are integrated in the CMTI 5.

It should also be observed that there are also integrated therein all of the systems services for enabling the application to be distributed over multiprocessor architectures and the communications functions enabling data mirroring to be performed in the embodiment of the system shown in FIG. 3 of the present application.

There are other differences that are just as fundamental, that consist in integrating real time communications objects in the core of the communicating architecture of the embodiment of the present invention. This embodiment thus enables each data item exchanged to be seen as a polymorphic object that is distributed in the system, processed by the parallel architecture, and integrated in the electronic component.

In conclusion, embodying an above-described system of the invention lies in implementing an architecture based on distributing data and services. The architecture is embodied in an electronic component that is interposed between the processor and the communications tools. It serves to off-load communications functions from the processor. It serves to transmit data exchanges between remote processors in a manner that is completely transparent for the application. It provides the resources needed for handling systems services enabling the multiprocessor architecture to be seen as a single processor. Finally, this communications electronic component can be thought of as a communications coprocessor enabling the distributed architecture to be embodied.

Thus, this communications component satisfies the initial problem, and that is not achieved with the embodiment of the prior art document referred to in the introduction, i.e. distributing data and services in industrial applications made using a distributed architecture, since it has to accommodate all of the application constraints.

This gives rise to the following additional advantages:

simplification in designing the application;

performance: the load on the CPU due to communications purposes is very low. The time required to access a particular data item is of the order of one-tenth of a microsecond, and synchronization accuracy is of microsecond order;

parameterization needs: because of the structure put into place, the behavior of each component can be parameterized either locally or remotely via the communications means; and

ease of developing the application, of updating it, and of maintaining it: because real time communications objects are used when providing the system, each data item is seen as being an independent entity without adherence to other distributed data items.

Naturally, other advantages exist that stem from this architecture, such as, for example: native handling of redundancy in the communications means, the (local and remote) parameterization mechanisms, error detection, etc.

The system of the invention described above finds numerous advantages. For example, it can be used for causing remote process means to communicate via a network known in the art as a control area network (CAN), such a network interconnecting at least one element having a given function, said element being of the producer type and/or of the consumer type.

A known defect of a CAN lies in the fact that it cannot guarantee a latency time for access to the various elements to which it needs to be connected. Only data having the highest priority at a particular instant can achieve this requirement.

The advantage that is obtained by coupling a CAN with a functional element by means of a system of the invention is to make the CAN deterministic, to ensure that different kinds of data transfer (cyclical, acyclical) can take place within the network, to release the CPU of all processing associated with communications, and to provide complete independence between the application and communications.

For each data item exchanged, this embodiment provides a communications port enabling each functional element (producer and/or consumer) to access the data in a synchronous manner so as to dissociate communications completely from the application. Nevertheless, it is still possible to work in synchronous mode if constraints associated with the application require that.

By this application of the system of the invention, it is also possible to ensure deterministic real time transmission of data in the CAN while complying with the constraints inherent to the application.

The system of the invention in this application provides three functions, namely:

simplified accessibility to the CAN. The application accesses data via the CMTI. As a result, access to communications data takes place for all the data via the simplified “read” and “write” software functions. Access to the data takes place in compliance with the methods included in the system;

data is made available to all of the elements that are connected to the CAN. Only the data used at a node of the network is actually present at that node;

it makes synchronization/time- and date-stamping/downloading/ . . . possible.

1. A real time communications system between at least two equipments (14, 15), the system being characterized in that it comprises:
a circuit (1) for producing information “CPI” to be transmitted and at least one circuit (2) for consuming said information “CCI”;
communications means (5) for transferring information “CMTI”; and
firstly mounted in co-operation between said CPI (1) and said CMTI (5):
WRITE function command means (6);
signaling means (8) for emitting signaling from the CMTI to the CPI to provide a write report in response to the transfer of the information following initialization of the WRITE function; and
means (13) for defining an optional event to enable the CMTI (5) to inform the CPI (1) that the information has been read by the CCI (2); and
secondly mounted in co-operation between the CCI (2) and the CMTI (5):
means (9) for defining an optional event enabling the CMTI (5) to inform the CCI (2) that information is present;
READ function command means (10); and
signaling means (12) for enabling the CMTI (5) to cause the information for the CCI (2) to be delivered to the CCI; and at least
two real time distributed databases (18, 19) associated with the CMTI (5) and respectively functionally associated with the CPI (1) and with the CCI (2).

2. A system according to claim 1, characterized by the fact that the CMTI (5) are arranged to perform a mirror function (17).

3. A system according to claim 2, for operation with consistent information, i.e. information having spatial consistency meaning that all of the data items duplicated in the CMTI (5) are identical, and time consistency meaning that all of the data items are identical in value at the same time, characterized by the fact that it further includes a communications network (Rc) interconnecting the local databases (18, 19).

4. A system according to claim 1, characterized by the fact that said CMTI (5) are arranged to authorize “one-to-one” and “one-to-N” types of communications.

5. A system according to claim 1, characterized by the fact that it presents a layer structure for providing communications between said mutually remote CPI (1) and CCI (2).

6. A system according to claim 5, characterized by the fact that said layer structure comprises four layers (111, 112, 113, 114) that are respectively:
a first layer (111) that is constituted by the CPI (1) and the CCI (2);
a second layer (112) that is constituted by application circuits (24);
a third layer (113) that is constituted by the CMTI (5) that integrates the databases (18, 19); and
a fourth layer (114) that is constituted in particular by a communications circuit (25).

7. A system according to claim 6, characterized by the fact that said second layer (112) is constituted, in association with each circuit (1) and (2), by application circuits (24) which are the application servers relying on said third layer (113).

8. A system according to claim 6, characterized by the fact that said third layer (113), constituted by the CMTI (5) comprise the databases (18, 19) in which the information (20, 21) is stored to which access can be obtained only through the access methods circuit (23) so as to guarantee the integrity of the information which is distributed in the CMTI (5) to provide services to the CPI (1) and the CCI (2), and service means (22) which are distributed in the CMTI (5) to provide services for time- and date-stamping and for synchronization to the various CPI (1) and CCI (2).

9. A system according to claim 8, characterized by the fact that it further comprise, in said third layer (113):
a properties logic unit (26) that handles the functional consistency of all of the circuits provided in the CMTI (5) by the properties that are specific thereto and that are associated bijective (one-to-one) manner with each item of information;
a behavior circuit (27) which, as a function of the properties of information items given by the properties logic unit (26), delivers the behavior to be applied during information transfer in the CMTI (5); and
a management circuit (28) which copies information between the remote databases (18, 19) in accordance with the behavior associated with each item of information transmitted by the behavior circuit (27).

10. A system according to claim 1, characterized by the fact that, by way of application, it is used for making remote process means communicate via a control area network (CAN).
